(19) United States
(12) Patent Application Publication
(10) Pub. No.: US 2007/0139852 A1
(43) Pub. Date: Jun. 21, 2007

(54) System and method for controlling spool motion in a valve

(76) Inventor: Johannes W. Reuter, Ypsilanti, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/640,647

(22) Filed: Dec. 15, 2006

Related U.S. Application Data
(60) Provisional application No. 60/750,917, filed on Dec. 16, 2005.

(51) Int. Cl. H01H 47/00

(52) U.S. Cl. 361/160

(57) ABSTRACT

A system for controlling the motion of a spool in a valve includes first and second coils and a spool selectively movable between a first position relative to the first coil and a second position relative to the second coil, wherein the first position and the second position of the spool are controlled according to a motion profile.

### CROSS-REFERENCE TO RELATED APPLICATIONS

This application claims priority to U.S. provisional application Ser. No. 60/750,917, filed Dec. 16, 2005, which is hereby fully incorporated by reference in its entirety.

### BACKGROUND

Solenoid valves (i.e., valves actuated by one or more solenoids) are electromechanical devices used to control the flow of liquids or gases in a fully opened or fully closed configuration. Solenoid valves operate by sending current through one or more coils to generate an electromagnetic force that moves a core or spool made from a magnetic in a desired direction (generally from a first position representing an open state to a second position representing a closed state, and vice versa). In known solenoid valve configurations, the motion of the spool as it traverses from one valve position to another is uncontrolled in that the spool velocity continues to increase as the spool approaches the second position, causing a high velocity impact. This uncontrolled motion and high-impact landing, particularly in fast-switching applications, creates operational noise, deterioration of parts, mechanical stresses and undesirable spool bouncing. Accordingly, the embodiments described hereinafter were developed in light of these and other drawbacks associated with the uncontrolled spool motion in solenoid valves.

### BRIEF DESCRIPTION OF THE DRAWINGS

FIG. 1 illustrates an exemplary dual coil valve assembly, according to an embodiment;

FIG. 2 is a process diagram illustrating exemplary steps for generating a motion profile, according to an embodiment;

FIG. 3A is a graph illustrating an exemplary position profile, according to an embodiment;

FIG. 3B is a graph illustrating an exemplary velocity profile, according to an embodiment;

FIG. 3C is a graph illustrating an exemplary relationship between the current and force in a valve assembly, according to an embodiment;

FIG. 3D is a graph illustrating an exemplary voltage profile, according to an embodiment; and

FIG. 4 illustrates an exemplary control feedback scheme, according to an embodiment.

### DETAILED DESCRIPTION

Introduction

A system and method for controlling the motion of a spool in a dual coil valve is provided. The system and method include controlling the motion of the spool by distributing current between both coils of the valve according to a predetermined, arbitrary motion profile. In other words, the motion profile establishes an optimal relationship between the current in a first coil and the current in a second coil, such that the coils work in tandem to control the motion of the spool to provide a “soft landing” before the spool comes into selective physical contact with a physical surface of a mating component as discussed below. The development of the motion profile includes generating offline an optimal motion profile based on desired spool behavior and practical constraints such as limits in admissible current and available driving voltage level, and performance indices such as energy and impact velocity. Once the offline motion profile has been generated, a feedback algorithm is applied to control and stabilize the motion profile and account for model and measurement uncertainties.

Exemplary System

Although one or more systems and methods for controlling the motion of a spool in a dual coil valve are described below with specific reference to a solenoid valve, one of ordinary skill in the art understands that the exemplary recitations may be applied to other mechanical valve designs including, but not limited to, spring loaded valves.

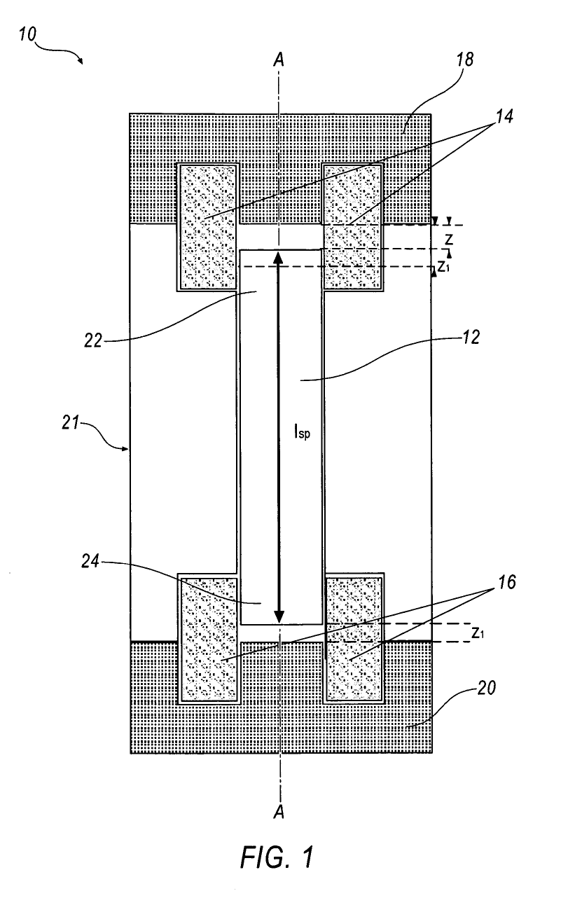

FIG. 1 illustrates a cross-sectional view of an exemplary solenoid valve assembly 10 having a movable spool 12 disposed between a first coil 14 and a second coil 16, each capable of generating an electromagnetic force upon the application of current. The first and second coils 14, 16 are partially mounted within cylindrical end caps 18, 20, respectively, of a housing 21 extending along a longitudinal axis A-A. A first end 22 of the spool 12 traverses through the interior space defined by the innermost periphery of the first coil 14, while a second end 24 of the spool traverses through the interior of the innermost periphery of the second coil 16. In the embodiment shown in FIG. 1, air gap Z is the current distance between end cap 18 and the first end 22 of spool 12 while air gap Z′ is the current distance between end cap 20 and the second end 24 of spool 12. Z₁ is the maximum value possible for Z and is the summation of Z and Z′. One of ordinary skill in the art recognizes that Z is a function of time and that the position of the spool 12, and therefore the air gaps Z and Z′ will vary during operation although Z₁, will remain constant. The overall air gap Z₁, will vary depending on the specific configuration of the valve assembly 10.

The relative movement of spool 12 with respect to the fixed elements of the housing such as coils 14 and 16 depends on the strength of the magnetic force generated by one or both of the first and second coils 14, 16. The strength of the magnetic force is in part a function of the current applied to the first and second coils 14, 16. Other factors include the length and mass of the spool 12, the extent of the air gap Z₁, and relative size of corresponding air gaps Z and Z′ and the magnetic flux through the coils 14, 16, which is created by the current through coils 14, 16. These relationships can be expressed with the following differential equations where i is the current through one of the first or second coils 14, 16, λ is the magnetic flux linkage, Z is the position of the spool 12 relative to end cap 18 as discussed above, V_{drv} is the driving voltage of the coils 14, 16, m is the mass of the spool 12, Cμ is the viscose friction coefficient and F_{mag} is the magnetic force.

$$\frac{ⅆ i}{ⅆ t} = {( \frac{\partial λ ( i , z )}{\partial i} )}^{- 1} ( - i {R}_{L} - \frac{\partial λ ( i , z )}{\partial z} \dot{z} + {V}_{drv} ) \qquad Equation 1$$

Equation 1 describes the change in current through one of the coils 14, 16 based on the applied driving voltage V_{drv}. Note that the change in current is calculated for only one coil at a time, depending on the starting position of the spool 12 (i.e., traversing from the first coil 14 to the second coil 16, or vice versa). The first parenthetical term of equation 1 represents the inductance through the coil. The first element of the second parenthetical term is the voltage drop due to the ohmic resistance (R_{L}) of the coil based on the applied current i. The second element in the second term is the induced voltage, which is the derivative of the flux linkage λ (a function of the current through the coil and the position of the spool) where \dot{z} is the velocity of the spool 12. The third and last element in the second term represents the driving voltage of the coil.

$$\frac{{ⅆ}^{2} z}{ⅆ {t}^{2}} = \frac{1}{m} ( {F}_{mag} ( i , z ) - {F}_{mag} ( 0 , {z}_{1} - z ) + {c}_{μ} \frac{ⅆ z}{ⅆ t} ) \qquad Equation 2$$

Equation 2 is derived from Newton's Second Law of Motion (i.e., F=ma, where F is the sum of all external forces, m is the mass and a is acceleration). Solving for the acceleration, equation 2 is expressed in terms of the second differential of the spool position, and equals the sum of all forces for spool 12. The first term within the parenthetical is the magnetic force due to the coil (one of either the first coil 14 or the second coil 16) as a function of the current through the coil and the position of spool 12. The second term is the force acting on the spool from the other side due to residual magnetic flux when the current is at zero. The third and last term is the force due to viscose friction, which is proportional to the velocity of spool 12.

Exemplary Process

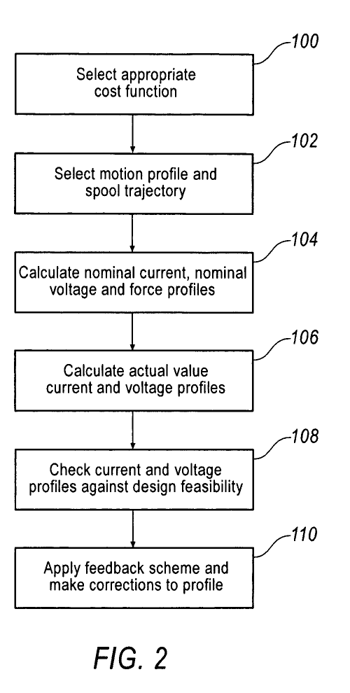

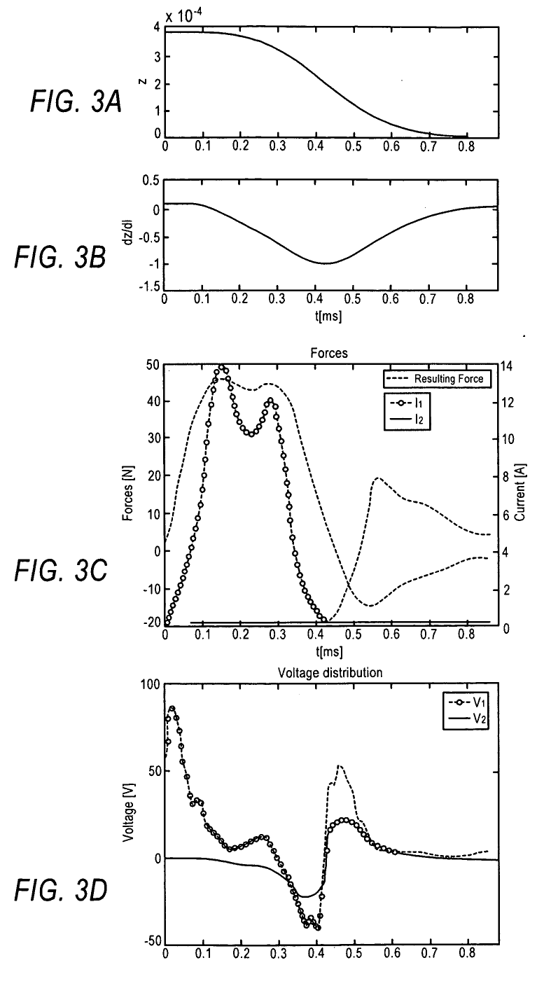

FIG. 2 is a flow diagram illustrating an exemplary process for generating a motion profile for controlling the motion of a spool in a dual coil valve. References to physical components refer to those exemplary components illustrated in FIG. 1. At step 100, an appropriate cost function is selected, which weights or limits certain design criteria such as, but not limited to, energy consumption and impact velocity. An arbitrary motion profile based on the position of spool 12 and a desired spool trajectory is then selected at step 102. An exemplary motion profile is shown in FIGS. 3A and 3B, where FIG. 3A illustrates the spool position Z over time t, and FIG. 3B illustrates the associated velocity of spool 12 as a function of velocity (dz/dt) over time as spool first end 22 approaches end cap 18 as discussed above. Note that the velocity in FIG. 3B appears negative because the position of the spool (i.e., the air gap Z) is decreasing over time. Looking at FIGS. 3A and 3B together, it is shown that as the air gap decreases, for example at time .4 ms, the absolute value of the velocity of spool 12 is nearly at a maximum. As the air gap further decreases, so does the absolute velocity of spool 12. As described in further detail below, the decrease in velocity, and thus the soft landing of the spool, is due to a current applied to the second coil, which based on the length of the air gap creates an opposing magnetic force to decrease the velocity of spool 12. In one embodiment, the length of the air gap is estimated based on the spool velocity, which is based on the voltage and current measurements. In another embodiment, the length of the gap is determined by proximity sensors mounted within the end caps 18, 20. In a spring loaded valve, the measured value may be a result of measured spring force.

Referring to FIG. 2, at step 104 the nominal voltage V*_{drv}(t) and the nominal current i*(t) in the first and second coil 14, 16 and the resulting force profile, are calculated based on the position of the spool and the desired spool trajectory (FIGS. 3A and 3B, respectively) that has been retrieved from step 102, using equations 1 and 2. This is possible from equations 1 and 2 since the system posses the property of differential flatness. It is necessary to correct the nominal values from step 104 due to measurement errors and model uncertainties. Thus, at step 106, the actual value for current and voltage for both the first and second coils 14, 16 are calculated using equation set 3 below.

Equation 3
i_{ctrl}(t)=i*(t)+α₁(z*(t)−z(t))+α₂(\dot{z}*(t)−\dot{z}(t))
v_{drv}(t)=v_{drv}*(t)+α₃(i_{ctrl}(5)−i(t))
with
v*_{drv}(t)=Φ₁⁻¹({dot over (\dot{\dot{z}})}*(t), \dot{\dot{z}}*(t), \dot{z}*(t), z*(t)
i*(t)=Φ₂⁻¹(\ddot{z}*(t), \dot{z}*(t),z*(t))

At step 108, the current and voltage profiles are checked against the feasibility of the design according to the previously established cost function and the physical limitations of the valve assembly 10. At step 110, corrections are made to the offline planned current and voltage profiles based on a standard feedback control loop. For example, i_{ctrl}(t) and V_{drv}(t) of equation set 3, illustrate a feedback loop (i.e., control law) that can be used to stabilize the motion profiles and correct any error due to inaccuracies in estimated values or measurements (e.g., current, voltage, coefficient of friction, etc.). The control law in equation set 3 uses the nominal values for voltage and current as feedforward quantities to compensate for nonlinear dynamics. Feedback is introduced by weighting the difference between the nominal quantities (denoted in equation set 3 by *) and the actual measured ones. This control structure is commonly known as a state space feedback controller with a dynamic compensation term.

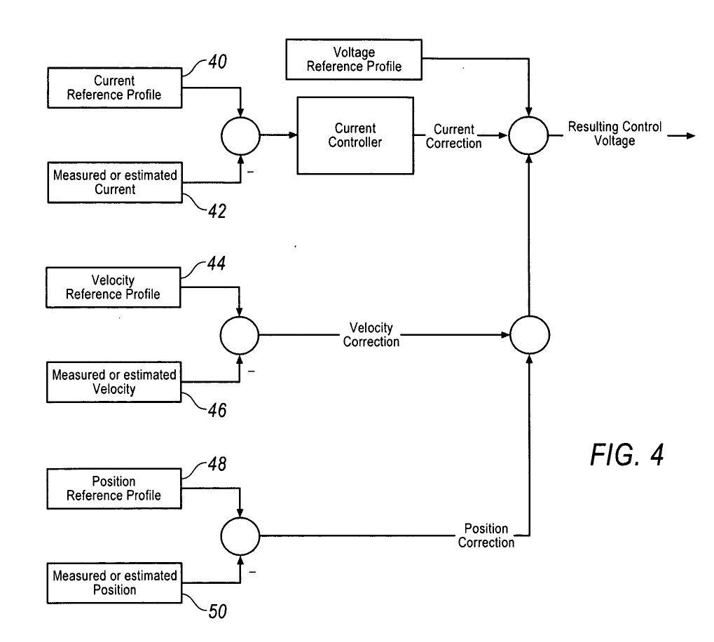

FIG. 4 illustrates the overall control scheme where the current reference profile 40 (offline generated profile) is compared with the measured or estimated current profile 42 (actual profile) to calculate the difference, which generates a current correction. Similarly, the velocity reference profile 44 is compared to the measured or estimated velocity 46 of the spool 12 to establish a velocity correction factor. The same principle applies to the position reference profile 48 and the measured or estimated position 50 of the spool 12 to get a position correction factor. Each of the correction factors are summed to create a control voltage that represents an optimized motion profile for valve assembly 10 such that the motion of the spool is controlled to provide a soft landing.

FIGS. 3C and 3D illustrate the resulting force profiles as a function of the current in both coils (FIG. 3C) and the resulting voltage distribution (FIG. 3D) for each of the first and second coils 14, 16. The overall motion profile for valve 10 is collectively illustrated by the graphs in FIGS. 3A-3D. FIG. 3C best illustrates the relationship between the current through each of the coils 14, 16; the resulting magnetic force for each coil 14, 16; and thus the impact on the velocity of spool 12. Note that from time 0 to approximately time equals 0.4 ms, the resulting force is due to the current in the first coil 14. By referencing FIGS. 3A and 3B, one can see that this is also the time at which the air gap has become small and the ideal maximum velocity has peaked. To achieve a soft landing, the current in the first coil 14 goes to zero (“0”), while the current in the second coil 16 increases, creating a magnetic force in the second coil 16 that opposes the magnetic field of first coil 14. This opposing force reduces the velocity of spool 12 as the air gap Z decreases to zero (“0”). The result is a soft landing.

While the present invention has been particularly shown and described with reference to the foregoing preferred embodiment, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and system within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A system, comprising:
a first coil and a second coil;
a spool selectively movable between a first position relative to said first coil and a second position relative to said first coil;
wherein said first position and said second position of said spool are controlled according to a motion profile.

2. The system of claim 1, wherein a current applied to said first coil and said second coil creates a magnetic force that controls the motion of said spool between said first position and said second position.

3. The system of claim 1, wherein said motion profile includes a first current applied to said first coil and a second current applied to said second coil such that the motion of said spool as it traverses from said first position to said second position, is controlled according to said motion profile.

4. The system of claim 3, wherein said first and said second currents are applied to said first and second coils to control the velocity of said spool to provide a reduction in velocity as said spool traverses from said first position and approaches said second position.

5. The system of claim 1, wherein said motion profile is an arbitrary motion profile selected according to a desired spool behavior.

6. The system of claim 1, wherein a first current applied to said first coil creates a magnetic force that causes said spool to traverse from said first position to said second position, and wherein a second current applied to said second coil creates an opposing magnetic force to decrease the velocity of said spool as it approaches said second position.

7. The system of claim 1, wherein said valve is a solenoid valve.

8. The system of claim 1, wherein said valve is a spring loaded valve.

9. The system of claim 1, wherein said second position has a physical surface of contact.

10. A method for controlling a spool in a valve, comprising:
selecting an arbitrary motion profile that controls the motion of a spool as it traverses from a first position to a second position to provide a reduction in velocity as the spool approaches said second position, and basing said motion profile on a position of the spool between a first coil and a second coil, and a desired spool trajectory;
calculating current and voltage values for each of said first and said second coils based on said arbitrary motion profile; and
generating a force profile based on said current and voltage values.

11. The method of claim 10, said current values including a first current and applying said first current to said first coil, thereby creating a magnetic force that causes said spool to traverse from said first position toward said second position, and including a second current and applying said second current to said second coil, thereby creating an opposing magnetic force and decreasing the velocity of said spool, providing a soft landing into said second position.

12. The method of claim 10, further including controlling the velocity of the spool as it traverses from a first position to a second position by applying a first calculated current to said first coil and creating a first magnetic force, and applying a second calculated current to said second coil and creating a second magnetic force opposing said first magnetic force, thereby decreasing the velocity of the spool as it approaches said second position.

13. A method for controlling a spool in a valve, comprising:
selecting an arbitrary motion profile controlling the motion of a spool as it traverses from a first position to a second position, said motion profile being based on a position of the spool between a first coil and a second coil, and a desired spool trajectory;
calculating nominal currents and nominal voltages for each of said first and said second coils based on said arbitrary motion profile;
calculating a force profile based on said nominal currents and said nominal voltages;
comparing said nominal currents and said nominal voltages to design feasibility criteria;
calculating actual current and actual voltage values for each of said first and said second coils;
comparing said nominal currents and said nominal voltages with said actual current and said actual voltages; and
determining a correction factor based on a difference resulting from said comparing of said nominal currents and voltages to said actual currents and voltages, wherein said correction factor compensates for measurement error and model uncertainties.
